(19) United States
(12) Patent Application Publication
(10) Pub. No.: US 2005/0165150 A1
(43) Pub. Date: Jul. 28, 2005

(54) Nonhalogenic flame-retardant adhesive tape and method for manufacturing the same

(76) Inventors: Masato Koike, Susono-shi, Shizuoka (JP); Susumu Hara, Susono-shi , Shizuoka (JP); Hiroshi Ichikawa, Susono-shi ,Shizuoka (JP)

Correspondence Address: SUGHRUE MION, PLLC, 2100 PENNSYLVANIA AVENUE, N.W., SUITE 800, WASHINGTON, DC, 20037, US

(21) Appl. No.: 10/505,687

(22) PCT Filed: Feb. 25, 2003
(86) PCT No.: PCT/JP03/02079

(30) Foreign Application Priority Data
Feb. 25, 2002 (JP) 2002-47910

(51) Int. Cl. C08K 3/10

(52) U.S. Cl. 524/436; 524/437

(57) ABSTRACT

A nonhalogenic flame-retardant adhesive tape comprising a tape substrate having provided thereon an adhesive layer, wherein the tape substrate is a resin composition having an oxygen index of 22 or more, said resin composition comprising a base resin with which a metal hydroxide is mixed, and said base resin comprising a reactive propylene soft resin, and wherein the tape substrate has a 100% modulus of less than 1.4 kgf/mm² at a tensile speed of 300 mm/minute, and a 100% elongation load of less than 0.2 kgf/mm per mm of width.

### FIELD OF THE INVENTION

This invention relates to an adhesive tape which is used for bundling or protection of electric wire and cable, particularly for a wiring harness for vehicles and relates to a nonhalogenic flame-retardant adhesive tape in which good usability as same as in the case of the conventionally and widely used adhesive tape made of poly(vinyl chloride) is achieved and toxic gas such as chlorine is not generated even when burned. This invention also relates to a method for the manufacture of the nonhalogenic adhesive tape.

### BACKGROUND ART

For bundling and protection of electric wire which constitutes a wiring harness for vehicles, there has been widely used an adhesive tape made of poly(vinyl chloride) (PVC) in which an adhesive layer is formed on one side of a tape substrate comprising soft poly(vinyl chloride) (PVC). In the adhesive tape made of PVC, there are advantages of good usability such as that degree of elongation when wound on electric wire constituting a wiring harness is appropriate, that it can be easily cut by hand upon cutting the tape, etc. and, in addition, there is an appropriate flame-retardant property as well.

In recent years however, preservation of the environment has been considered to be important and there is a tendency that the use of plastics of a vinyl chloride type which are thought to be the sources for generation of toxic dioxin is suppressed and thereby development of substitutes for adhesive tapes made of PVC is in progress. For example, in the gazette of U.S. Pat. No.3,007,081, there is described a nonhalogenic flame-retardant adhesive tape in which the tape comprises a resin composition having an oxygen index of 22 or more in which a nonhalogenic flame retardant is mixed with an olefinic polymer and an adhesive layer is formed on one side of a tape substrate in which a 25% modulus at a tensile speed of 300 mm/minute is from 0.8 to 1.5 kgf/mm², a 100% modulus is from 1.4 to 2.0 kgf/mm², tensile strength per mm width upon 100% elongation is from 0.2 to 0.4 kgf/mm and elongation upon breakage is 100% or more.

### DISCLOSURE OF THE INVENTION

However, although the above nonhalogenic flame-retardant adhesive tape shows a good bundling force to electric wire having relatively big diameter and hardness such as power cable, it shows a poor following property to electric wire when winding on electric wire having a relatively small diameter such as an electric wire constituting a wiring harness for vehicles, and there are problems that lifting (gap) is apt to be formed between the tape and the electric wire when bundled and that the bundled electric wire becomes loose or the finished appearance is inferior. In addition, hardness of the tape substrate is somewhat high and, therefore, a wiring harness has a poor softness and it makes a bad operability in attaching to vehicles, etc.

Further, when a calendar molding having a quick production speed is carried out in the manufacture of a tape substrate, the tape substrate which is a molding material adheres to roll and, therefore, the manufacture is carried out either by a T die molding or by an inflation molding. However, a T die molding usually has a slow production speed and, as compared with a calendar molding, its productivity is only about one-third. Furthermore, although an inflation molding shows somewhat high production speed as compared with that of a T die molding, its productivity is usually less than about one-half of the calendar molding. Moreover, in an inflation molding, there is a disadvantage that variation in thickness of the resulting tape substrate is big as compared with other methods.

The present invention has been achieved in view of the circumstances as such and provides a nonhalogenic flame-retardant adhesive tape having similar flame-retardant property to adhesive tape made of PVC, producing no toxic gas even when burned, having better usability and softness than adhesive tape made of PVC and conventional nonhalogenic flame-retardant adhesive tape, being suitable especially as a wiring harness for vehicles and being able to carry out an easily operation of attaching the wiring harness to vehicles, etc. This invention provides a method for the manufacture the above nonhalogenic flame-retardant adhesive tape in a high productivity as well.

In order to achieve the above objects, this invention provides a nonhalogenic flame-retardant adhesive tape comprising a tape substrate having provided thereon an adhesive layer,
wherein the tape substrate is a resin composition having an oxygen index of 22 or more, said resin composition comprising a base resin with which a metal hydroxide is mixed, and said base resin comprising a reactive propylene soft resin, and
wherein the tape substrate has a 100% modulus of less than 1.4 kgf/mm² at a tensile speed of 300 mm/minute, and a 100% elongation load of less than 0.2 kgf/mm per mm of width.

This invention further provides a method for producing a nonhalogenic flame-retardant adhesive tape, which comprises:
(a) mixing a base resin comprising a reactive propylene soft resin with a metal hydroxide to thereby prepare a resin composition having an oxygen index of 22 or more;
(b) subjecting the resin composition to a calendar molding to thereby prepare a tape substrate having a predetermined thickness; and
(c) forming an adhesive layer on one surface of the tape substrate.

### BEST MODE FOR CARRYING OUT THE INVENTION

This invention will now be illustrated in detail as follows.

With regard to a tape substrate in the nonhalogenic flame-retardant adhesive tape of this invention, metal hydroxide as a flame retardant is mixed with a base resin containing a reactive propylene soft resin and the resulting resin composition is molded into a shape of tape. In the propylene soft resin of a reaction type, propylene and ethylene propylene are polymerized at the same time and, as compared with other propylene resins, it has a high softness thereby a tape substrate having a high softness can be prepared. In addition, the reactive propylene soft resin is an olefin type and is a non-crosslinked type and, therefore, it has an advantage that it can be recycled easily.

Examples of the characteristics of the reactive propylene soft resin are that specific gravity is about 0.88 (JIS K7112), tensile strength upon100% elongation is about 6.7 MPa (JISK6251), tensile breaking stress is about 14 MPa (JIS K6251) and MFR is about 1.5 G/10 minutes (JIS K7210).

In the present invention, the term “soft” is defined as HDD of 60 or less under JIS K7215.

The reactive propylene soft resin is available in the market as well and, for example, “M142E”, “R110E”, etc. which are the products of a low-hardness grade for extrusion molding manufactured by K. K. Tokuyama may be appropriately used.

The base resin may be either a sole reactive propylene soft resin mentioned above or a mixture thereof with other resin upon necessity. With regard to the resin which may be mixed, olefinic resin such as polyethylene or polypropylene may be listed. A mixing ratio at that time is appropriately selected within a range satisfying the latter-mentioned tensile characteristic upon making into a tape substrate.

With regard to metal hydroxide which is a flame retardant, known one such as magnesium hydroxide, aluminum hydroxide and calcium hydroxide may be used and two of more thereof may be mixed and used as well. Mixing amount of the metal hydroxide with a base resin is selected so as to satisfy the similar flame-retardant property to adhesive tape made of PVC or, specifically, oxygen index of 22 or more (JIS K7201-2) and the latter-mentioned tensile characteristic when made into a tape substrate.

As the mixing amount of the metal hydroxide increases, the flame-retardant property becomes high, while the tensile characteristic lowers. In the present invention, even though flame-retardant property has priority, it is preferred that the mixing amount of the metal hydroxide is suppressed to an extent of about 50 parts by weight based on 100 parts by weight of the base resin.

The base resin maybe appropriately mixed with antioxidant, colorant, inorganic filler, lubricant, softener, ultraviolet absorber, etc. within such an extent that flame-retardant property and tensile characteristic are not lowered. All of them may be known ones which are commonly mixed with adhesive tapes.

The resin composition which is constituted as above is molded into a shape of tape to give a tape substrate and, in the present invention, a calendar molding method having an excellent production speed can be adopted therefor. In the manufacture of the conventional nonhalogenic flame-retardant adhesive tapes, tape substrate is manufactured by means of a T die molding or an inflation molding. This is because, in a resin composition in which common olefinic resin is used as a base resin, a tape substrate which is a molded product adheres to a roll when a calendar molding is carried out. Therefore, up to now, it is unavoidable to manufacture by means of methods in which the production speed is low such as a T die molding (about one-third of the calendar molding method) or an inflation molding method (about one-half thereof). In addition, in an inflation molding, there is a disadvantage that variation in thickness of the resulting tape substrate is big as compared with that in other methods. In the present invention, a propylene soft resin of a reaction type is used, thereby it is now possible to manufacture a tape substrate by a calendar molding method in which adhesion to roll does not take place, production speed is high and variation in thickness is small.

The condition for the calendar molding is not particularly limited but maybe appropriately set depending upon constitution of the resin composition, aimed tape thickness, etc.

It is preferred that the thickness of the resulting tape substrate is from 0.03 to 0.4 mm or, particularly, from 0.05 to 0.15 mm. When the tape thickness is less than 0.03 mm, it is too thin to give sufficient strength whereby the tape is apt to be broken. On the other hand, when the tape thickness is more than 0.4 mm, cutting by hand becomes difficult and workability becomes poor.

In the present invention, the tensile characteristic of the tape substrate is that a 100% modulus at a tensile speed of 300 ml/minute is less than 1.4 kgf/mm² and a load upon a 100% elongation per mm of the width is less than 0.2 kgf/mm.

When the 100% modulus becomes 1.4 kgf/mm² or more, the tape is hardly elongated in winding the tape around electric wire and lifting is apt to be resulted between the tape and the electric wire. It is particularly preferred that the 100% modulus is from 0.7 to 1.2 kgf/mm².

When a 100% elongation load per mm of the width becomes 0.2 kgf/mm or more, the tape is hardly elongated as same as above and, when electric wire is bundled to prepare a wiring harness, the wiring harness shows poor softness which badly affects the operation of its attachment to vehicles, etc. It is particularly preferred that a 100% elongation load per mm of the width is from 0.04 to 0.1 kgf/mm.

After that, an adhesive layer is formed on one side of the above tape substrate, and thereby the nonhalogenic flame-retardant adhesive tape of the present invention is completed. Incidentally, the adhesive may be that which has been known for adhesive tapes and there is no limitation for the layer thickness as well. In addition, there is no limitation for the method of forming an adhesive layer and, for example, there may adopt a method in which an adhesive is dissolved in an appropriate solvent and the resulting applying solution is applied to a tape substrate and dried.

### EXAMPLES

The invention will be explained below in more detail by reference to Examples. However, the invention should not be construed as being limited to these Examples.

(Preparation of Adhesive Tape Sample)

“M142E” manufactured by K. K. Tokuyama (a reactive propylene soft resin) (100 parts by weight) was mixed with 40 parts by weight of magnesium hydroxide and well kneaded and the resulting resin composition was subjected to a calendar molding method (production speed: 50 m/min) to give a tape substrate having a thickness of 0.050 mm. An adhesive was applied onto this tape substrate and dried to prepare a nonhalogenic flame-retardant adhesive tape (a product of the present invention).

For the sake of comparison, a resin composition was prepared by mixing 50 parts by weight of an ethylene-ethyl acrylate copolymer, 40 parts by weight of an ethylene-vinyl acetate copolymer, 10 parts by weight of polypropylene and 40 parts by weight of magnesium hydroxide and subjected to an inflation molding method (production speed: 20 m/min) to give a tape substrate having a thickness of 0.050 mm. An adhesive was applied onto the tape substrate and dried to prepare a nonhalogenic flame-retarding adhesive tape (a conventional product).

Also for the sake of comparison, a tape substrate having a thickness of 0.050 mm was prepared using poly(vinyl chloride) molding materials by a calendar molding method (production speed: 50 m/min). An adhesive was applied onto the tape substrate and dried to prepare an adhesive tape made of PVC.

(Measurement of Tensile Characteristic)

Each of the tape substrates was subjected to measurements of 100% modulus, load upon 100% elongation per mm of width and tensile strength under the condition of tensile speed of 300 mm/minute. The result is shown in Table 1.

(Confirmation of Lifting of Tape)

Thirty electric wires each having full length of about 350 mm and diameter of 0.5 mm were tied up in a bundle and then bundled by means of a half-wrapping (piling of one-half width of the full width of the tape) of each of the above adhesive tapes. Then it was allowed to stand for a predetermined period and the lifting between the adhesive tape and the electric wire was checked by naked eye. The result is shown in Table 1.

(Evaluation of Softness of Wiring Harness (WH))

Thirty electric wires each having full length of about 350 mm and diameter of 0.5 mm were tied up in a bundle and then bundled by means of a half-wrapping of each of the above adhesive tapes to prepare a sample. The sample was set on a pair of cylinders (diameter: 19 mm) arranged with an interval of 100 mm in such a manner that the sample crossed the cylinders at right angles.

After that, the surrounding was kept at a measuring temperature (−10° C., 10° C. or 30° C.), the sample was pulled down at the central part between the cylinders and the highest load from the sample was bent until it fell down from the cylinders was measured. The result is shown in Table 1.

TABLE 1

| | | | Conventional | Product of the | Adhesive Tape |
|---|---|---|---|---|---|
| Evaluated Items | | Unit | Product | Invention | made of PVC |
| 100% Modulus | | kgf/mm² | 1.4 | 1.0 | 1.4 |
| 100% Elongation Load | | Kgf/mm | 0.2 | 0.05 | 0.1 |
| Tensile Strength | | kgf/mm² | 2.4 | 2.0 | 2.4 |
| Lifting of Tape | | — | noted | Not noted | not noted |
| Softness | −10° C. | N | 110 | 105 | 120 |
| of WH | 10° C. | N | 65 | 60 | 70 |
| | 30° C. | N | 40 | 40 | 40 |
| Productivity | Molding Method | — | inflation | calendar roll | calendar roll |
| | Production Speed | m/min | 20 | 50 | 50 |
| | Thickness Variation | — | big | substantially | substantially nil |
| | | | | nil | |

As shown in Table 1, it was noted that the product of the present invention showed no lifting of the tape and had good softness in bundling a wiring harness particularly at low temperatures as compared with the adhesive tape made of PVC and with the conventional product.

Tape thickness of the tape substrate was also measured and variation in the tape thickness was noted in the conventional product.

### INDUSTRIAL APPLICABILITY

As illustrated hereinabove, it is now possible to efficiently manufacture a nonhalogenic flame-retardant adhesive tape having similar flame-retarding property to adhesive tape made of PVC, producing no toxic gas even when burned and having better usability and softness than adhesive tape made of PVC and conventional nonhalogenic flame-retardant adhesive tape.

1. A nonhalogenic flame-retardant adhesive tape comprising a tape substrate having provided thereon an adhesive layer,
wherein the tape substrate is a resin composition having an oxygen index of 22 or more, said resin composition comprising a base resin with which a metal hydroxide is mixed, and said base resin comprising a reactive propylene soft resin, and
wherein the tape substrate has a 100% modulus of less than 1.4 kgf/mm² at a tensile speed of 300 mm/minute, and a 100% elongation load of less than 0.2 kgf/mm per mm of width.

2. The nonhalogenic flame-retardant adhesive tape according to claim 1, wherein the tape substrate has a thickness of 0.03 to 0.4 mm.

3. The nonhalogenic flame-retardant adhesive tape according to claim 1 or 2, wherein the tape is useful for bundling and protection of wiring harness for vehicles.

4. A method for producing a nonhalogenic flame-retardant adhesive tape, which comprises:
(a) mixing a base resin comprising a reactive propylene soft resin with a metal hydroxide to thereby prepare a resin composition having an oxygen index of 22 or more;
(b) subjecting the resin composition to a calendar molding to thereby prepare a tape substrate having a predetermined thickness; and
(c) forming an adhesive layer on one surface of the tape substrate.
